(19) United States
(12) Patent Application Publication
(10) Pub. No.: US 2009/0050441 A1
(43) Pub. Date: Feb. 26, 2009

(54) METHOD OF SECURING TROLLEYS BY A DEPOST, AND DEPOST SYSTEM

(76) Inventor: Gottfried Wanzl, Leipheim (DE)

Correspondence Address: BUCHANAN, INGERSOLL & ROONEY PC, POST OFFICE BOX 1404, ALEXANDRIA, VA, 22313-1404, US

(21) Appl. No.: 11/996,136

(22) PCT Filed: Jul. 18, 2006
(86) PCT No.: PCT/EP06/07060

§ 371 Date: Jul. 14, 2008

(30) Foreign Application Priority Data
Jul. 20, 2005 (DE) 20 2005 011 624.6

(51) Int. Cl. G07F 7/02; G07F 7/06; G07F 9/10

(52) U.S. Cl. 194/210; 194/353; 194/350

(57) ABSTRACT

The invention relates to a method of securing shopping trolleys (10), for which a defined parking area (9) is provided, by a deposit and to a deposit system for such trolleys. The deposit (7) is introduced into a deposit device (30) which is arranged in the parking area (9) separately from the shopping trolleys (10), the deposit device (30) freeing a shopping trolley (10) for removal from the parking area (9) by means of a signalling arrangement (18). The signalling arrangement (18) here interacts with an inhibiting device (26) on the shopping trolley (10) for inhibiting the movement of the trolley by remote control, the signalling arrangement (18) communicating in a wireless and trolley-specific manner with signalling devices (22) on the shopping trolley (10) and the signalling arrangement (18) registering the return of a shopping trolley (10) in order for the deposit to be refunded.

### TECHNICAL FIELD

The disclosure relates to a method of securing trolleys, especially shopping trolleys, by means of a deposit and to a deposit system having the features set out in the preambles of the main method claim and the main device claim.

### BACKGROUND

It is known from DE 297 24 850 U1 to mount coin- or chip-operated deposit locks on shopping trolleys. The nestable shopping trolleys can be joined together by means of the deposit locks and locking chains. To accommodate the trolleys, one or more defined parking areas are provided, in which a row of trolleys can be secured by means of fixedly mounted locking chains. To prevent overflow of the parking areas as a result of too many parked shopping trolleys, on the one hand coloured identifications for the shopping trolleys and on the other hand different and colour-specific lock types are provided in a limited number according to the available parking capacity.

WO 2004/055743 A1 shows a further development of this deposit-lock system, in which the positions of the shopping trolleys in the parking area are additionally monitored. In this case, a position detector interacts with a transmitting device and a receiver on the deposit lock, whereby the deposit lock can only be operated for return of the deposit when a release signal is transmitted by the transmitting device. Such a release signal is transmitted if the parking area has sufficient reception capacity and if the shopping trolley is parked at a permitted point within this area. However, if a row of trolleys has already reached its maximum length, a shopping trolley which is pushed in at the end of the row in an undesired manner is detected as being incorrectly positioned, with the result that the release of the deposit is inhibited by means of a corresponding blocking signal, and only after the shopping trolley has been moved to a permitted point is the deposit released.

EP 0 141 285 A1 discloses a storage facility for supermarket shopping trolleys, with a mechanical removal and return passage barrier, a money collection point for opening the passage barrier and a money return point for when the shopping trolley is brought back to the storage facility. The storage facility is surrounded by solid walls, wherein the passage points are also mechanically and physically secured by controllable gates which form the passage barrier. Each shopping trolley has its own data code, wherein readers are arranged at the removal and return passage barriers and, according to the data code, allow or block the passage of the shopping trolley. In this way, removal of shopping trolleys without prior payment of a deposit is prevented and return of the deposit is also only rendered possible when the shopping trolley is brought back to its allocated storage facility.

Another deposit system with remotely controllable deposit locks, which can only be operated in the region of a parking box, is known from WO 2004/016138 A1. The shopping trolleys have a mechanical deposit lock with a chain, by means of which they are coupled together in the parking box in a conventional manner. The deposit lock additionally has a receiver for wireless communication with a transmitter which is located in the parking box and locks or unlocks the deposit lock by remote control. Outside the parking box and the transmission range, the deposit locks are locked, which prevents shopping trolleys from being coupled in an undesirable manner. The transmitters can be coded so that the deposit lock is unlocked and the deposit returned only in the allocated parking box.

An anti-theft securing means for a trolley is known from DE 203 14 705 U1 and has an inhibiting device, formed as a caster-locking device, on the shopping trolley and a signal transmitter at the entrances or boundaries of a commercial premises, within the site of which the shopping trolley may be moved. If an attempt is made to remove the shopping trolley from this permitted area and e.g. push it home, the signal transmitter is passed and triggers the inhibiting device, which impedes or prevents the manoeuvrability of the shopping trolley by positively blocking the swivel bearing of one or more casters.

U.S. Pat. No. 6,362,728 B1 teaches a similar anti-theft securing device with an inhibiting device on one or more casters and a signal transmitter at the site boundaries. The inhibiting device is formed here as a wheel brake which is integrated into the caster.

U.S. Pat. No. 5,194,844 A discloses a further anti-theft securing device of the aforementioned type with a remotely controllable inhibiting device which acts on the caster of a shopping trolley via a braking member.

### OBJECT AND SUMMARY

The object of the present disclosure is to improve the securing of trolleys, especially shopping trolleys, by means of a deposit.

The disclosure achieves this object by means of the features set out in the main method claim and the main device claim. With the technique according to the disclosure, the deposit device can be removed from the trolleys and positioned elsewhere, e.g. in a parking area. Deposit locks on the trolleys can be dispensed with. The trolleys no longer have to be joined together. The deposit system can also be used with trolleys of different types. These trolleys can be nestable in a space-saving manner. However, this does not necessarily have to be the case.

The securing and return of a trolley simply against payment of a deposit is implemented in co-operation with an inhibiting device on the trolleys. The known mechanical passage barriers at storage facilities or parking boxes are unnecessary. The structural expenditure for the trolley parking areas can be reduced considerably.

For securing a trolley by means of a deposit, the same inhibiting device can be used as that which can also be used for an anti-theft securing device or which has already been provided for this. This dual use is a particular advantage of the disclosure.

In such anti-theft securing systems, the deposit system according to the disclosure can be retrofitted without major additional expenditure and, optionally, networked. The deposit system can also be operated independently of an anti-theft securing device. It can be integrated into new constructions or be retrofitted or supplemented in old constructions or reconstructions. Furthermore, the deposit system can be installed together with an anti-theft securing device by corresponding incorporation into an overall logistics system.

The expenditure for the deposit system can be kept low owing to the versatility of the inhibiting device. A combined deposit and anti-theft securing system offers maximum use with minimum structural and financial expenditure and also makes such systems affordable for smaller businesses and trolley parks. Extension of the implemented technique to further application possibilities within the framework of an overall logistics system, e.g. determination of customer and purchasing behaviour, improvement of marketing, logistics or the like, is also possible with little additional expenditure.

A trolley can be released only against payment of a deposit. This can take place in various ways. In the one variant, the inhibiting devices of the trolleys located in the parking area can be closed and are opened only upon payment of a deposit, in which case e.g. the inhibiting device of only a single trolley is released, which is indicated to the customer in a suitable manner. He can then remove the trolley with the released inhibiting device. The others remain in their place.

In the second and, for energy reasons, preferred variant, the inhibiting devices of the trolleys located in the parking area are open. One or more entrances to or in the parking area are wired up by the deposit device in such a way that, in the manner of a virtual barrier, they can only be passed by a trolley when a deposit has previously been paid. Otherwise, the virtual barrier remains closed. For this purpose, local antennae or other signal transmitters, which transmit control signals to the inhibiting device of a trolley moving past and close it by remote control, can be provided at the entrances. In this case, the inhibiting function can be the same as for an anti-theft securing device. The trolley removed without a deposit can then no longer be manoeuvred in a serviceable manner.

The deposit system can be coupled to a control device for controlling the occupancy of the parking area. This control device can function in various ways. In the one variant, each trolley has its own code, wherein the trolleys are allocated to specified parking areas. It is also possible for the trolleys to be more precisely allocated to a specified parking zone, e.g. a row of trolleys, within a specified parking area. When a trolley is returned, its association with the parking area or, if applicable, also with a specified parking zone can be checked and identified via the code. Only when the allocation is correct and the trolley has been returned is the deposit reimbursed. The level of occupancy of the parking area can also be monitored via this occupancy control. In the case of zone division, an undesired excessive length of the parking rows is thereby automatically prevented at the same time.

Otherwise, this length control for the parking rows can also take place via the antennae or signal transmitters at the entrances. Furthermore, the occupancy control for the parking areas can be used for optimisation of the trolley logistics, wherein imminent occupancy shortages are signalled to a supervisor, who can then take appropriate remedial action. To make clear the allocation of the trolleys to specified parking areas, the trolleys and the parking areas can have suitable identification means, e.g. different colorations.

The deposit system according to the invention has the great advantage that, owing to the deposit devices which are preferably arranged in a parking area or, optionally, are allocated to a plurality of parking areas, payment of the deposit can be made more convenient. In the known deposit locks with one or a maximum of two coin types, the limitations were substantially greater. In the deposit devices according to the disclosure, a monetary deposit can be tendered via a coin machine or, alternatively or additionally, via a writer/reader for value data carriers, e.g. vouchers, cheque cards, credit cards, charge cards or the like. As a result, a substantially larger range of payment means is available, which, moreover, can be currency-independent.

In addition, this provides the further advantage that the amount of the deposit can be set at will and also be changed again. Furthermore, the amount required for the deposit can be adapted to different customer groups. This is possible e.g. via a charge card, by means of which bulk consumers, by way of a bonus, only have to pay a small deposit or even no deposit at all. In a further variant, it is possible to set deposits of different values for different types of trolley. Lastly, the deposit device according to the disclosure also provides the possibility of using other types of deposit instead of or in addition to money, e.g. tokens, chips, deposit substitutes for personnel for maintenance purposes or the like.

The deposit can be reimbursed at the deposit device itself or at another point, e.g. a check-out. In this case, the amount used as a deposit can be reimbursed as cash or in cashless form by being credited back to a value data carrier. As a modification, it is possible for the deposit to be reimbursed in a form other than that in which it was paid and e.g. to issue a coupon upon reimbursement. During reimbursement, with reference to the trolley code, personal or customer assignment can also take place, by means of which customer-specific benefits, e.g. bonus payments, can be made upon return of the deposit or also at another point on the commercial premises.

The coding of the trolleys can be undertaken in any suitable manner and be detected and processed by the deposit device or its signalling arrangement. This can be visual coding, e.g. coloration or reference numbers, or other such visually or haptically detectable individual features. The trolleys can also be fitted with a more highly functional signalling device which can contain one or more signal transmitters of the same or different types which e.g. wirelessly exchange signals and/or data with the signalling arrangement of the parking area. These signal transmitters can be e.g. transponders, wherein, apart from the code, other data can also be stored in the signal transmitter and, optionally, overwritten and changed. Data stores of this type, which can be interrogated, can be used in a variety of ways on the commercial premises and also in the parking area. It is possible to store here e.g. information relating to the fact of payment of the deposit and the amount of the deposit and optionally also customer-specific data from a charge card or the like. For example, this assures preferential customers special treatment at the check-out or the like.

The inhibiting device can be constructed in any manner. In this case, it is possible to use e.g. the swivel brakes, wheel brakes or the like which are known from the initially quoted prior art.

Further advantageous embodiments of the disclosure are set out in the sub-claims.

### BRIEF DESCRIPTION OF THE DRAWING FIGURES

The disclosure is shown schematically and by way of example in the drawings, wherein in detail:

FIG. 1 shows a schematic plan view of a commercial premises, especially a supermarket, with trolleys and a deposit system;

FIGS. 2 and 3 show schematic plan views of a parking area with a deposit device for a plurality of trolleys;

FIG. 4 shows a side view of a trolley;

FIG. 5 shows an enlarged side view of a caster of a trolley; and

FIG. 6 shows a schematic view of a transponder.

### DETAILED DESCRIPTION

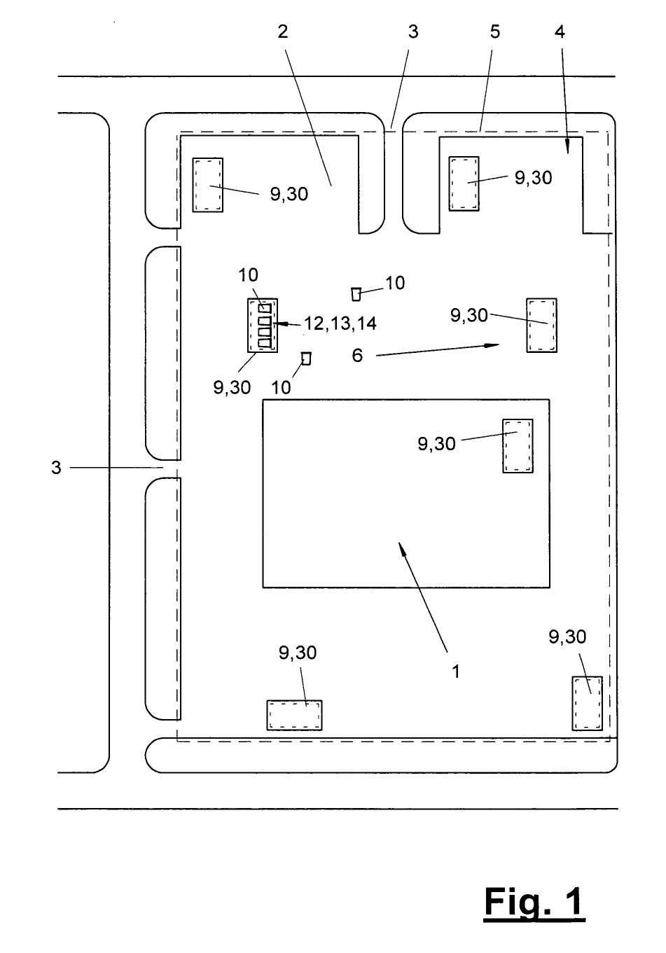

FIG. 1 shows a schematic plan view of a commercial premises (1), for example a supermarket or other shop with a commercial building and a surrounding open-air site (2), especially a trolley park. The trolley park can also be incorporated into the building. Alternatively, the commercial premises (1) can take any other form and be an airport, a railway station or the like.

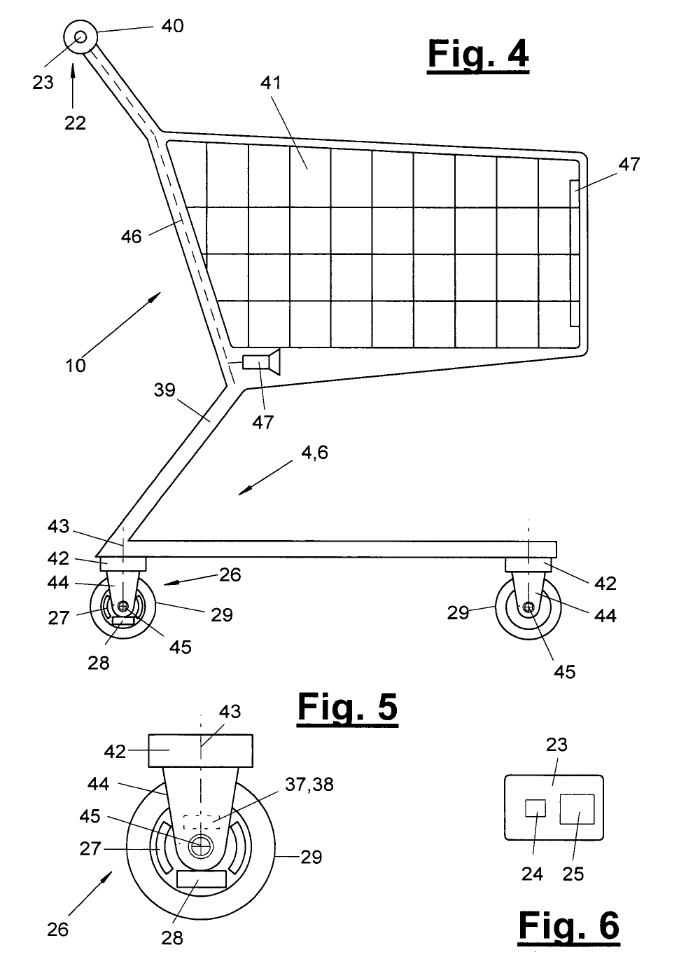

A plurality of trolleys (10) are provided on the commercial premises (1) and are accommodated in one or more defined parking areas (9) on the site or in the trolley park (2). One or more parking areas (9) can also be provided inside the building, e.g. in the entrance area. FIG. 4 shows a schematic side view of such a trolley (10) in a preferred embodiment as a shopping trolley.

The site (2) has one or more entrances or approach roads (3), via which the customers gain access to the site (2) on foot or by a mode of transport. In order to prevent trolleys (10) from being taken away in an undesirable manner, an anti-theft securing device (4) can be provided, which can be formed in any manner and has e.g. at least one signal transmitter (5) at the entrances (3) and, optionally, at the outer boundaries of the site (2). For example, the signal transmitter (5) can be formed as a circumferential antenna cable which is sunk into the ground. When a trolley (10) travels over the signal transmitter (5), a control signal is transmitted to an inhibiting device (26)—which will be described hereinbelow—of the trolley (10) and closes the inhibiting device (26) and impedes or prevents further movement of the trolley (10). The deposit system (6) also utilises the same or another inhibiting device (26) on the trolley (10).

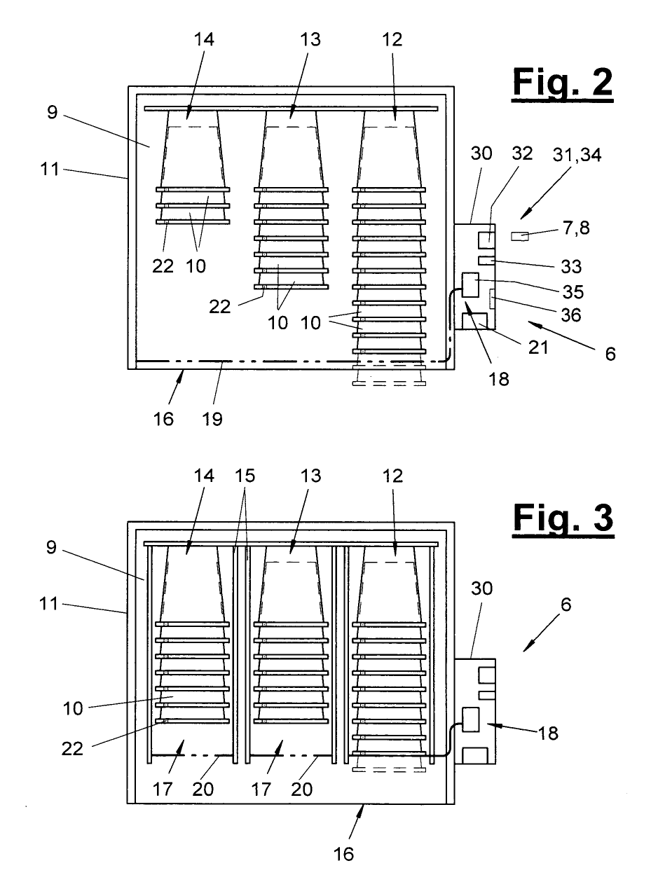

As FIGS. 2 and 3 show, the parking areas (9) can have a surrounding housing (11) or another boundary with one or more entrances (16) and are formed e.g. as parking boxes in which the trolleys (10) can be parked randomly or, preferably, in one or more rows. The trolleys (10) can be of the same or a different type and size. In particular, they can be structurally adapted to one another so that they can be pushed together and nested in a space-saving manner. However, this does not have to be the case. Alternatively, it can also be provided that only trolleys (10) of the same type are nestable.

The housing (11) can comprise a solid wall or a lattice of bars or the like. A roof can also be provided. The laterally bounded parking area (9) can have one or more central entrances (16). Within the parking area (9), a plurality of parking zones (12, 13, 14) can be provided for identical or different trolleys (10). These are e.g. the parking rows (12, 13, 14) which are shown in FIGS. 2 and 3 and which can be bounded at the front and the sides by guides (15) for the trolleys (10). These parking zones (12, 13, 14) have their own entrances (17) within the parking area (9).

As a modification of the embodiment shown, the parking area (9) can have a virtual and invisible boundary which is operated by signal technology and the opening and closing of which can be controlled as a function of the payment of a deposit. The parking area (9) can be marked on the ground in a visually perceptible manner by boundary lines or by other means.

The trolleys (10) preferably do not have individual deposit locks and locking chains for fixedly joining them together within the parking row (12, 13, 14). Instead, one or more deposit devices (30) are provided which are arranged separately from the trolleys (10) and are fitted at least with a receiving device (31) for the collection of a deposit (7) and which preferably also have a dispensing device (34) for reimbursement of the deposit. After payment of a deposit (7), a trolley (10) can be removed from the parking area (9). After the trolley (10) has been returned, the deposit (7) is reimbursed.

An individual deposit device (30) is preferably associated with each parking area (9) and is fixedly arranged in the direct vicinity of the parking area (9). For example, the deposit device (30) is located on the outer wall of the parking box (11). Alternatively, one deposit device (30) can be associated with a plurality of parking areas (9) and be arranged in a central position on the site (2), the respective association being signalled to the customer or trolley user via a display (36).

The deposit devices (30) interact with the inhibiting devices (26) on the trolleys (10) by means of a signalling arrangement (18) and, after payment of a deposit (7), permit the removal of a trolley (10) by remotely controlling the inhibiting devices (26) accordingly. This can take place in the various ways described hereinbelow. If a deposit (7) is not paid, the deposit device (30) can e.g. prevent the removal of a trolley (10) by activating the inhibiting devices (26) accordingly.

Alternatively, the return of a trolley (10) can also be registered and, optionally, the deposit (7) reimbursed by the deposit device (30). In this case, the trolleys (10) can be specifically allocated to particular parking areas (9) or, optionally, to predetermined parking zones (12, 13, 14) within a specified parking area (9). The deposit (7) is only reimbursed when the trolley (10) is returned to its allocated parking area (9) or allocated parking zone (12, 13, 14) first.

FIGS. 2 and 3 schematically show the structure of the deposit device (30). The receiving device (31) for the deposit (7) can be formed in various ways. The deposit (7) itself can be of a monetary nature and be paid as a cash sum in coins or notes. Alternatively or additionally, a monetary deposit (7) can be paid via a value data carrier (8). This can be a voucher, a chip or the like, which represents a deposit value. In the preferred embodiment, the value data carrier (8) is formed as an electronically debitable card, e.g. a charge card, cash card, cheque card or the like. For this purpose, the receiving device (31) can have at least one writer/reader (33) for debiting and preferably also crediting sums of money. In this respect, the writer/reader (33) can also be part of the dispensing device (34) for reimbursement of the deposit.

For cash payment, a coin machine (32) is provided which accepts cash in different coin denominations and optionally also different notes and which also changes money. At the same time, the coin machine (32) can also be part of the dispensing device (34) for reimbursement of the deposit (7). Alternatively, the dispensing device (34) can reimburse the deposit (7) in another form, e.g. as a coupon, especially a purchase coupon. In principle, the deposit (7) can be of any type and does not have to have a monetary value, in which case the receiving and dispensing devices (31, 34) are adapted and formed accordingly.

The deposit device (30) contains a preferably electronic and programmable controller (35) which has one or more data stores and is connected to the receiving and dispensing device (31, 34). In addition, the deposit device (30) can have one or more displays (36), e.g. visual displays for signal lights, display texts, graphic symbols, pictograms or the like. The display (36) can optionally also provide acoustic information relating to announcements or the like. Furthermore, for security reasons it can have an alarm system which signals operating errors, break-ins, removal of a trolley without authorisation or without payment of a deposit, or the like.

The deposit device (30) also has a signalling arrangement (18) which interacts with the inhibiting devices (26) on the trolleys (10) for inhibiting trolley movement by remote control. The signalling arrangement (18) can be formed in various ways.

In the embodiment shown in FIGS. 2 and 3, it has signal transmitters (19, 20) e.g. at the entrances (16, 17) to the parking area (9). In particular, these can be combined transmitters and receivers for wireless communication with the inhibiting devices (26), e.g. by radio, ultrasound, infrared or the like. In the preferred embodiment, the signal transmitters (19, 20) are local radio antennae which are arranged in the ground area at the entrances (16, 17) and over which trolleys (10) travel when they are removed and returned. These antennae (19, 20) can be formed in the same way as the initially mentioned signal transmitter (5) of the anti-theft securing device (4).

In the embodiment shown in FIG. 2, the signal transmitter (19) extends over the entire width of the single entrance opening (16). If it is possible to remove trolleys (10) on several sides, a signal transmitter (19) of this type is located at each entrance (16). In the variant shown in FIG. 3 with the mutually delimited parking zones (12, 13, 14), an associated signal transmitter (20) is provided at the entrance (17) to each parking zone (12, 13, 14). In this case, a central signal transmitter (19) at the entrance (16) can be omitted. The signal transmitters (19, 20) are connected via cables or the like to the controller (35) and are switched by the latter.

As a modification of the embodiment shown, signal transmitters (19, 20), especially local ground antennae, can e.g. form the aforementioned virtual boundary of the parking area (9) and replace the housing (11). In the region of the specially marked entrances (16, 17), the signal transmitters (19, 20) can be switchable for opening and closing purposes and can have a permanent blocking function in the other boundary regions.

In the one embodiment variant shown, the inhibiting devices (26) of the trolleys (10) within the parking area (9) and, if applicable, also within the parking zones (12, 13, 14) are open so that here the trolleys (10) can be freely moved within the boundary. In the starting position, a blocking signal is generated at the entrances (16, 17) by the signalling arrangement (18) via the signal transmitters (19, 20). In this case, the signal transmitters (19, 20) have a relatively small range so that the free movement of the trolleys (10) within the parking area (9) is not disrupted. Only if a trolley (10) should be removed without payment of a deposit and, in so doing, is moved past a signal transmitter (19, 20) is the inhibiting device (26) closed by the permanent blocking signal and movement of the trolley inhibited. The trolley (10) then cannot be manoeuvred and used in the normal manner.

When the trolley (10) is brought back again to the parking area (9) or, if applicable, a specified parking zone (12, 13, 14), the inhibiting device (26) can be automatically opened again and the trolley movement enabled. For this purpose, e.g. in the outer area in front of the entrance (16, 17), trolley detection can take place, e.g. by signal technology using a ground antenna. Alternatively, the opening of the inhibiting device (26) can also be effected via a separate signal transmitter, e.g. a hand-held unit with a transmitter or the like.

If a sufficient deposit (7) is paid to the deposit device (30) in the intended manner, the accordingly activated signalling arrangement (18) switches off at least one of the signal transmitters (19, 20) and permits the removal of at least one trolley (10) according to the value of the deposit. In the embodiment shown in FIG. 2, any trolley (10) can be removed from the parking area (9). In the variant shown in FIG. 3, individual or all parking zones (12, 13, 14) can be unblocked for removal of a trolley. If there is a particular association between a parking zone (12, 13, 14) and the deposit (7), one zone is selectively unblocked. This can be the case e.g. if different trolleys (10) are arranged in the parking zones (12, 13, 14) and, furthermore, also if different deposits (7) are to be paid for different trolleys (10).

The signal transmitters (19, 20) are preferably formed not only as transmitters, but also as receivers. In this way, the removal of a trolley (10) can be registered so that the release function of the signalling arrangement (18) is then cancelled and the normal blocking function is restored.

The return of a trolley (10) can also be detected via the signal transmitters (19, 20) or another device so that, for this purpose, the signalling arrangement (18) is likewise switched into the open position and allows the free passage of the trolley (10) without actuation of the inhibiting device (26).

In the aforementioned manner, the trolleys (10) can have a predetermined association with specified parking areas (9) and, optionally, also with specified parking zones (12, 13, 14) therein. In order to ensure this association, the trolleys (10) can have a signalling device (22) with a unique code (24). The code (24) can take various forms, e.g. coloured markers, characters or the like, but also other individualised design features of the individual trolleys (10), said features being detected by the signalling arrangement (18) in a suitable manner. This is possible optically, for example by means of an electronic camera with image evaluation, by light-barrier scanning or the like. Contactless codes (24) and their detection are preferred. Alternatively, contact-type detection is also possible, e.g. using tracer fingers or the like.

In the preferred embodiment, the code (24) is stored in at least one signal transmitter (23) on the trolleys (10). This signal transmitter (23) is preferably formed as an active or passive transponder with a simple reading function or a combined reading/writing function. The code (24) can be interrogated wirelessly by means of radio waves, electromagnetic fields or the like in any manner. Alternatively or additionally, the signal transmitter (23) can have a data store (25) for the permanent or temporary storage of further information. This data store (25) can be read and, optionally, written by external action by at least one suitable transmitter positioned at any point on the commercial premises (1), and its information content can be changed. The code (24) can also be integrated into the data store (25).

The signalling arrangement (18) can have a suitable receiver (21) for acquisition of the codes (24) and, optionally, the data store (25). The receiver (21) is connected to the controller (35). It can simultaneously be formed as a transmitter in order to reply and send information back to the data store (25). The transmitter/receiver (21) is formed e.g. as a radio device for wireless communication with the transponder (23).

By means of the codes (24), logistical administration of the trolleys (10) can take place. The trolleys (10) located in the respective parking area (9) and, if applicable, additionally allocated to the respective parking zones (12, 13, 14) are stored, together with their codes (24), in the controller (35) of the deposit device (30). Removal of a trolley (10) can also be registered, stored and processed via the code (24). In this way, when a trolley (10) is returned it is possible to check and determine the allocation via the communication between the signalling arrangement (18) and the signalling device (22). In this case, the signal transmitter (19, 20) is switched off and the entrance (16, 17) to the parking area (9) or the allocated parking zone (12, 13, 14) is unblocked. Other entrances (16, 17), however, are blocked. With reference to the codes (24), the controller (35) knows which and how many trolleys (10) are available in the parking area (9) or in the parking zones (12, 13, 14) and, optionally, where they are located. This can be determined e.g. via the temporal order in which the trolleys are returned and via zone allocation.

Other, e.g. customer-relevant information can also be stored in the data stores (25) and be kept ready for remote interrogation. In this case, receipt information relating to payment of the deposit can be stored, for example. If it is nevertheless possible to remove a trolley (10) from the parking area (9) without payment of a deposit owing to a defective inhibiting device (26) or for some other reason, the receipt information is missing from its data store (25). When the data store (25) is checked in the entrance area of the shop, these trolleys (10), for which a deposit has not been paid, can be identified and countermeasures implemented.

Further customer-relevant information which is storable in the data store (25) is e.g. information relating to the customer's status as a preferential customer or the like. Furthermore, rights of access to particular areas of the commercial premises (1), e.g. a wholesale area, can be stored. The customer's name, preferred goods ranges, etc. can also be stored. By means of this data and information now provided in the trolley (10), communication can take place with access controls, advertising transmitters, greetings displays and the like on the commercial premises (1). The data store (25) can then be used for data communication instead of the charge card.

The level of occupancy in the parking area (9) or in the parking zones (12, 13, 14) can also be checked via the stored codes (24) and their internal administration in the deposit device (30). If only the allocated trolleys (10) may be brought back and parked, overfilling is eliminated from the outset. On the other hand, a trolley supply which is running low can be identified via the codes (24) or via the controller counting the incoming and outgoing trolleys (10) and can be reported to a logistics administration system on the commercial premises (1), which then ensures that the necessary trolleys (10) are rearranged and returned. This can be the case e.g. in an airport, a railway station or other such traffic centres where the trolleys (10) usually have a one-way route and are not brought back to the parking area (9) by the customers. The operator has to ensure this return via the logistics administration system.

The trolleys (10) can also be used without a code (24). Overfilling of the parking area (9) or the parking zones (12, 13, 14) can then be detected and prevented via the signal transmitters (19, 20). As FIGS. 2 and 3 show, in which trolleys (10) are represented by broken lines in the right-hand rows of trolleys, the signal transmitters (19, 20) are located at the rear ends of the rows of trolleys or the parking zones (12, 13, 14). When the intended occupancy level has been reached, the next trolley (10) parked at the end of the row cannot come into switching contact with the signal transmitter (19, 20). This switching contact is necessary for return of the deposit, with the result that the deposit (7) is not reimbursed. In such a case, it can be signalled to the customer or trolley user via a corresponding entrance monitoring system that he should take his trolley (10) to another parking area (9) or to another parking zone (12, 13, 14). In this way, via reimbursement of the deposit, the rows of trolleys can be prevented from reaching an undesired excessive length and projecting out of the parking area (9).

In the second functional variant, the signalling arrangement (18) in the normal state can close the inhibiting devices (26) of all trolleys (10) located within the parking area (9) or parking zones (12, 13, 14) and thereby prevent movement of the trolleys. Only upon payment of a deposit (7) is at least one inhibiting device (26) opened so that the relevant trolley (10) can be removed. The identity of the released trolley (10) can be signalled to the customer via the display (36). In this case, the signalling arrangement (18) has other types of signal transmitter (19, 20), which are formed e.g. as radio apparatus with a transmitter and receiver. In such a case, a code (24) can be required for selectively releasing one or more specified trolleys (10) or their inhibiting devices (26). Alternatively, all inhibiting devices (26) can be opened for removal of a trolley and, after removal has taken place, be closed again.

Apart from the above-described variants for signal transmission and for the release and blocking function, there are optional other design possibilities, in which case combined forms of the above-described embodiments are also possible.

FIGS. 4 and 5 illustrate, by way of example, the technical configuration of a trolley (10), which has e.g. a frame (39) with a goods receptacle (41), here e.g. a basket, a pushing means (40), e.g. a handle, and a plurality of casters (29). The trolley (10) shown is formed as a shopping trolley. Alternatively, the trolley can be a luggage trolley, a platform trolley or the like. The goods receptacle (41) is then, accordingly, differently formed and arranged. The trolley (10) can be pushed or pulled by means of the handle (40). In this case, four uniformly distributed casters (29) are provided for easy manoeuvrability and are mounted in caster holders (44) so as to be freely rotatable about a transversely extending caster axis (45). For their part, the caster holders (44) can be pivotably mounted on the frame (39) via a swivel bearing (42) with a vertical swivel axis (43). The number of casters (29) and their arrangement can vary. Also, not all casters (29) have to have a swivel bearing (42).

The inhibiting device (26) can be formed in any suitable manner and be provided on the trolley (10) in any suitable number. In the embodiment shown, the inhibiting device (26) is a wheel brake (27) arranged inside or on the caster (29). It can be constructed e.g. in accordance with U.S. Pat. No. 6,363,728 B1 and can have the brake shoes indicated in FIGS. 4 and 5 for frictional contact with a brake drum inside the caster (29). Alternatively, it can be a positively engaging braking member. Instead of inhibiting the rolling movement of the caster (29) about the caster axis (45), it is also possible to inhibit its swivelling movement about the swivel axis (43) and, in so doing, block it positively or brake it frictionally. Such an arrangement can be formed e.g. in accordance with DE 203 14 705 U1.

In the various embodiments, the inhibiting device (26) in each case has an integrated controller (28) which actuates the respective braking member via a suitable drive (not shown). The controller (28) is associated with a suitable receiver (37) for picking up the control signals, which are transmitted by the signalling arrangement (18) via the signal transmitters (19, 20) and optionally by the anti-theft securing device (4) via the signal transmitter (5). The inhibiting device (26) can also have a suitable energy store (38), e.g. a battery integrated into the caster (29) or a rechargeable storage battery for supplying energy to the controller (28), the braking member and the receiver (37). Furthermore, the caster (29) can be associated with a current generator which taps the rolling or travelling motion and converts the kinetic energy into electrical energy for feeding the energy store (38). In a further modification, the receiver (37) can additionally be formed as a transmitter and transmit status information or other data outwardly, preferably wirelessly.

Furthermore, one or more indicating devices (47) can be provided on the trolley (10) and are connected to the energy store (38) or another energy store, optionally via the schematically indicated lines (46). The signal transmitter or transponder (23), arranged e.g. in the handle (40), can also be supplied with electrical voltage in this manner. The indicating device (47) can be formed e.g. as a display which is mounted in the basket (41) for displaying advertising information, routes within the commercial premises (1) or the like. Apart from this type of arbitrarily formable optical indicating device (47), an acoustic indicating device (47) can alternatively or additionally also be provided, which is formed e.g. as a loudspeaker, a horn or the like. In this way, simple warning signals, but also more complex information, such as announcements or the like, can be transmitted.

The embodiments shown can be modified in various ways. This concerns e.g. the structural configuration and arrangement of the inhibiting device (26), which can be constructed in any manner and be e.g. a direct drive integrated into the caster (29) for generatory braking, or a friction brake coming into contact with the ground, or the like. The signalling device (22) and the signal transmitter (23) can also be integrated into the inhibiting device and its transmitter/receiver (37). The association can also be reversed.

### LIST OF REFERENCE NUMERALS

1 Commercial premises, supermarket, airport
2 Site, trolley park
3 Entrance, approach road
4 Anti-theft securing device
5 Signal transmitter, antenna
6 Deposit system
7 Deposit, sum of money
8 Value data carrier, card
9 Parking area
10 Trolley, shopping trolley
11 Housing, parking box
12 Parking zone, parking row
13 Parking zone, parking row
14 Parking zone, parking row

### 15 Guide

16 Entrance to parking area
17 Entrance to parking row
18 Signalling arrangement in parking area
19 Signal transmitter, sender/receiver, antenna
20 Signal transmitter, sender/receiver, antenna
21 Sender/receiver, radio device
22 Signalling device of trolley
23 Signal transmitter, transponder

### 24 Code

25 Data store
26 Inhibiting device
27 Wheel brake

### 28 Controller

### 29 Caster

30 Deposit device
31 Receiving device
32 Coin machine

### 33 Writer/reader

34 Dispensing device
35 Controller with memory

### 36 Display

### 37 Receiver/transmitter

38 Energy store, battery, storage battery

### 39 Frame

40 Pushing means, handle
41 Goods receptacle, basket
42 Swivel bearing
43 Swivel axis
44 Caster holder
45 Caster axis

### 46 Line

47 Indicating device

1. A method of securing trolleys by a deposit, for which at least one defined parking area is provided, the method comprising: receiving the deposit in at least one deposit device upon collection of the trolley, releasing the trolley for removal from a parking area via a signalling arrangement, and reimbursing the deposit after the trolley has been returned, wherein the deposit is introduced into the at least one deposit device which is arranged separately from the trolleys, wherein the signalling arrangement interacts with inhibiting devices on the trolleys for inhibiting trolley movement by remote control.

2. A method according to claim 1, wherein the signalling arrangement registers the return of a trolley for reimbursement of the deposit.

3. A method according to claim 1 wherein the deposit is introduced into and reimbursed by the at least one deposit device associated with at least one parking area.

4. A method according to claim 1, wherein the signalling arrangement communicates wirelessly with signalling devices on the trolleys.

5. A method according to claim 4, wherein the signalling arrangement and the signalling devices on the trolleys exchange signals and/or data in a trolley-specific manner.

6. A method according to claim 1, wherein an entrance to or in the parking area is operated by the signalling arrangement in interaction with the inhibiting devices and, upon payment of the deposit, is opened for removal of the trolley and is otherwise closed.

7. A method according to claim 1 wherein the inhibiting devices of the trolleys located in the parking area are activated by the signalling arrangement, wherein, upon payment of the deposit, one or more inhibiting devices are released for removal of the trolley.

8. A method according to claim 1, wherein the trolleys are coded and allocated to specified parking areas, wherein the deposit is reimbursed only when a trolley is returned to its allocated parking area.

9. A method according to claim 1, wherein the deposit is reimbursed only when a trolley is returned to a predetermined parking zone within an allocated parking area.

10. A method according to claim 1, wherein the deposit is collected in cash or in cashless form by means of a value data carrier.

11. A method according to claim 1, wherein the deposit is reimbursed in cash or in cashless form by means of a value data carrier.

12. A method according to claim 1, wherein the deposit is paid and reimbursed by means of a debitable/creditable cash or charge card.

13. A method according to claim 1, wherein the deposit is reimbursed in a form other than that in which it was received, especially as a coupon.

14. A deposit system for trolleys, having a plurality of trolleys, at least one defined parking area for a plurality of trolleys and at least one deposit device for receiving and, optionally, reimbursing a deposit, wherein the deposit device is arranged separately from the trolleys and has a signalling arrangement for the remote control of inhibiting devices, which are located on the trolleys and inhibit trolley movement.

15. A deposit system according to claim 14, wherein the signalling arrangement has at least one signal transmitter for the wireless transmission of control signals for opening and/or closing the inhibiting devices.

16. A deposit system according to claim 14, wherein signal transmitters for the remote control of an inhibiting device which has moved past are arranged at one or more entrances to or in the parking area, wherein the signal transmitters are ground antennae.

17. A deposit system according to claim 14, wherein, within the parking area, the inhibiting devices of the trolleys located therein are open, wherein the signalling arrangement opens an entrance for removal of a trolley upon payment of a deposit and allows a trolley through, and otherwise, without payment of a deposit, transmits a control signal for closing the inhibiting device of a trolley moving past.

18. A deposit system according to claim 14, wherein, within the parking area, the inhibiting devices of the trolleys located therein are closed, wherein the signalling arrangement transmits a control signal for opening the inhibiting device of a trolley upon payment of a deposit for removal of a trolley.

19. A deposit system according to claim 14, wherein the trolleys have a signalling device with a trolley-specific code.

20. A deposit system according to claim 14, wherein the signalling device has a readable and writable data store.

21. A deposit system according to claim 14, wherein the signalling device has an active or passive signal transmitter.

22. A deposit system according to claim 14, wherein the signal transmitter is formed as a transponder.

23. A deposit system according to claim 14, wherein the signalling arrangement of the deposit device has a receiver and, optionally, a transmitter for wireless communication with the signalling devices on the trolleys.

24. A deposit system according to claim 19, wherein the coded trolleys are allocated to specified parking areas or predetermined parking zones, especially parking rows, within a specified parking area, wherein the codes of the allocated trolleys are stored in a controller of the deposit device.

25. A deposit system according to claim 14, wherein the deposit device is fixedly arranged in the parking area.

26. A deposit system according to claim 14, wherein the deposit device has a coin machine and/or a reader/writer for value data carriers.

27. A deposit system according to claim 14, wherein the deposit device has a dispensing device for a deposit substitute.

28. A deposit system according to claim 14, wherein the deposit device has a display.

29. A deposit system according to claim 14, wherein the parking area has a surrounding housing with at least one entrance.

30. A deposit system according to claim 14, wherein the parking area has one or more guides for the formation of a plurality of delimited parking zones, each having at least one entrance of its own.

31. A deposit system according to claim 14, wherein the inhibiting device is formed as a remotely controllable wheel brake in or on at least one caster of the trolley.

32. A deposit system according to claim 14, wherein the inhibiting device has a controller with an energy store and a receiver.

33. A deposit system according to claim 14, wherein the deposit system is provided for a commercial premises, and co-operates with an anti-theft securing device of the trolleys.

34. A deposit system according to claim 14, wherein the anti-theft securing device has at least one signal transmitter, at the entrances and, optionally, the outer boundaries of the site of the commercial premises.
